(19) United States
(12) Patent Application Publication
(10) Pub. No.: US 2006/0139575 A1
(43) Pub. Date: Jun. 29, 2006

(54) Optical collection and distribution system and method

(75) Inventors: Mikko Petteri Alasaarela, Oulu (FI); Ilkka Antero Alasaarela, Haukipudas (FI)

Correspondence Address: HARRINGTON & SMITH, LLP, 4 RESEARCH DRIVE, SHELTON, CT, 06484-6212, US

(73) Assignee: Upstream Engineering Oy

(21) Appl. No.: 11/314,348

(22) Filed: Dec. 20, 2005

Related U.S. Application Data
(60) Provisional application No. 60/638,911, filed on Dec. 23, 2004.

(51) Int. Cl. G03B 21/00

(52) U.S. Cl. 353/31

(57) ABSTRACT

An optical module includes a light source and a reflective substrate. A first optical medium is disposed such that the first optical medium in combination with the reflective substrate substantially envelops the light source. A second optical medium is disposed to contact the first optical medium, defining a boundary therebetween. Reflective sidewalls bound a lateral portion of the second optical medium. A lens has a lower surface in contact with the second optical medium and spaced from the first optical medium. Light from the source passing through the lens follows a first and a second optical path, the first including refraction at the boundary followed by refraction at the lens; and the second including refraction at the boundary followed by reflection from a sidewall followed by refraction at the lens. An alternative embodiment uses the reflective sidewalls to bound the first optical medium, and the second path differs.

### CROSS REFERENCE TO RELATED APPLICATIONS

This Application claims priority to U.S. Provisional Patent Application Ser. No. 60/638,911 filed on Dec. 23, 2004. This application is also related to co-pending and co-owned U.S. patent application Ser. No. 10/622,296 filed on Jul. 17, 2003 and entitled “2D/3D Data Projector”; and No. 11/051,652 filed on Feb. 4, 2005 and entitled “Method for Manufacturing Three Dimensional Optical Components”.

### TECHNICAL FIELD

The present invention relates to optical collection and distribution systems such as imaging projectors or beam shaping systems using a non-lasing light source.

### BACKGROUND

There is an increasing demand for optical collection and distribution systems on the micro scale, parallel to the demand for digital cameras on a micro scale that are now deployed in mobile telephones and common security systems. The intrinsic challenges in a micro-device approach is to collect light from the optical source (e.g., LED, filament, arc) in a small physical space with little loss. Optical efficiency is important for example in projector applications. Merely increasing power leads to prohibitive power consumption when the optical system is disposed in a battery-operated appliance, and increases problems with managing heat dissipation.

As an additional figure of merit, it is often desirable for an optical system to provide uniform illumination at a rectilinear imaging surface. This is because people expect to view a rectilinear image rather than an elliptical one. It is considerably difficult task to provide that uniform illumination, and it is achieved at the cost of efficiency. For example in data projectors, the resulting non-uniformities are evident in darker screen corners. Resolving these non-uniformities becomes more difficult with smaller projecting devices.

In general, prior art collection optics collect light emanating from the source to a spatially larger beam with a smaller opening angle, for example by using a cylindrically symmetrical collimator. The related beam forming components such as lenses, lightpipes, or micro-optical “top-hat” components, shape the beam to better fit an optical engine input. An optical engine is an optical component that manipulates light between the collecting/distributing apparatus and the target surface/viewing screen. Because the light source generates light from a smaller physical area than that needed for the input filed at the optical engine, these prior art approaches require physical space to propagate light intensity to the proper position. To the inventors' knowledge, prior art light collection and beam shaping systems are efficient and small in size only for cylindrically symmetric systems, or systems in which the light emanating from the collimator defines a circular cross-section. Further, the prior art appears to accept relatively large losses of light in that not all light from the source is collected. The prior art solutions are large in physical size, and some of them are not amenable to a heat sinking mechanism by which to draw off heat from the light source.

Some specific prior art approaches to beam-shaping are now broadly presented. In a first conventional approach depicted in prior art FIG. 1A, light from a source 12 is gathered in a collimator 14 and directed to a condenser lens 16, which then focuses its incident light into a lightpipe 18. In this approach, illumination from the lightpipe 18 exit may be substantially uniform if the lightpipe 18 is sufficiently long. However, the exiting light is generally not optimized for input into an optical engine (detailed in the context of the present invention below). More fundamentally, this approach is necessarily large in size due to the length of the optical path from the collimator 14 to the lightpipe 18, and to the length of the lightpipe 18 itself. Further, the lightpipe 18 increases losses, increasing the need for a more intense light source 12.

A second conventional approach is shown at FIG. 1B. A LED chip 12 is disposed within a cone or well defined by reflecting concave surfaces of a lighting case 20, in such a way that the light is leaving the case only upwards and mostly inside a smaller cone. This is sometimes referred to as a surface emitting LED. The case constrains the emitted light to a circular cross section, and those light rays are directed toward a beam shaper 22, which redirects the rays towards the optical engine. The beam shaper may also convert the cross section of its incident light to more resemble a rectilinear cross section. The second conventional approach imposes difficulties also. Because the light incident to the beam shaper must be collected and at least partially collimated, the problems with the first conventional approach are not overcome but merely shifted in space to within the surface emitting LED (the source 12/case 20 combination). Currently available surface-emitting LEDs fail to preserve etendue (described in the Detailed Description section) of their internal LED chip. In other words the brightness of the surface emitting LED is smaller than the brightness of the LED chip inside it or the total output power of the surface emitting LED is smaller than the total output power of the LED chip inside it.

FIG. 1C shows a third conventional approach where a cylindrically symmetric collimator 14 is used to collect the light from the source 12. The first micro-optical beam shaper 24 is used to convert the cylindrically symmetric intensity distribution into rectilinear distribution onto the second micro-optical beam shaper 28, which turns the rays into the proper angular distribution for an optical engine 19. Because light is first collected by a cylindrically symmetric component and then converted to a rectilinear field, a gap 26 is needed between the first and second beam shaping components for transporting the intensity to the correct position. This gap together with the relatively large size of the collimator 14, which is needed for decreasing the beam numerical aperture enough for the beam shapers, means that the solution is large in size.

FIG. 1D shows a fourth conventional approach where a cylindrically symmetric collimator 14 is used to collect the light from the source 12 into a rectangular lightpipe 18 placed directly after the collimator 14. In order to obtain a sufficient degree of collimation, the collimator 14 is lengthened. Similarly, in order to obtain sufficient uniformity at the output of the lightpipe 30, the lightpipe 18 is lengthened. This results in a large apparatus. Additionally, the light field at the lightpipe 18 output is generally not optimized to the optical engine of projectors, which results in excess losses from the optical engine. Further, light coupling from the circular collimator 14 to the generally rectangular lightpipe 18 causes etendue to increase, which results in decreased illumination brightness.

The present invention seeks to overcome at least some of the above difficulties and undesirable tradeoffs.

### SUMMARY

The foregoing and other problems are overcome, and other advantages are realized, in accordance with the presently preferred embodiments of these teachings.

In accordance with one embodiment, the invention is a method for manipulating light. In the method, light is emitted from a multi-directional source. The light is collected and spatially distributed using at least one patterned optical surface while substantially preserving etendue of the emitted light. The collected light is distributed angularly using at least one second optical surface while substantially preserving the etendue of the collected light.

In accordance with another aspect, the invention is an optical module that includes a multi-directional light source and a substrate that has a reflective surface facing the light source. A first optical medium defining a refractive index greater than unity is disposed such that the first optical medium in combination with the reflective substrate substantially envelops the light source. A second optical medium is disposed to be in contact with the first optical medium, and a boundary is defined between the first and second optical mediums. The optical module further includes reflective sidewalls that bound a lateral portion of the second optical medium, and a lens having a lower surface in contact with the second optical medium and spaced from the first optical medium. The above recited components are arranged such that light from the source passing through the lens follows a first and a second optical path. The first optical path includes refraction at the boundary followed by refraction at the lens. The second optical path includes refraction at the boundary followed by reflection from a sidewall followed by refraction at the lens.

In accordance with another embodiment, the invention is an optical module that also includes a multi-directional light source and a substrate having a reflective surface facing the light source. A first optical medium defining a refractive index greater than unity is disposed such that the first optical medium in combination with the reflective substrate substantially envelops the light source. A second optical medium is disposed to be in contact with the first optical medium, and a boundary is defined between the first and second optical mediums. The optical module further includes reflective sidewalls that bound a lateral portion of the first optical medium, and a lens having a lower surface in contact with the second optical medium and spaced from the first optical medium. The above recited components are arranged such that light from the source passing through the lens follows a first and a second optical path. The first optical path includes refraction at the boundary followed by refraction at the lens. The second optical path includes reflection from a sidewall followed by refraction at the boundary followed by refraction at the lens.

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein:

FIG. 1A is a schematic diagram of a first prior art conventional approach to beam collection and distribution.

FIG. 1B is a schematic diagram of a second prior art conventional approach to beam collection and distribution.

FIG. 1C is a schematic diagram of a third prior art conventional approach to beam collection and distribution.

FIG. 1D is a schematic diagram of a fourth prior art conventional approach to beam collection and distribution.

FIG. 2A is a cut-away plan view of an optical module 30 according to the preferred embodiment of the present invention.

FIG. 2B is an exploded view of the embodiment of FIG. 2A.

FIG. 3A is a cut-away plan view of an optical module 30′ according to an alternative embodiment of the present invention, absent the substrate 34 of FIG. 2A to better delineate the distinctions.

FIG. 3B is an exploded view of the embodiment of FIG. 3A.

FIG. 4 is a schematic block diagram of an optical module arranged with a micro-display and imaging unit.

FIG. 5 is a schematic block diagram of three different color optical modules whose output is combined prior to passing through a micro-display and imaging unit.

FIG. 6 is similar to FIG. 5 but with the light passing through micro-displays prior to being combined.

FIG. 7 is a schematic block diagram showing a polarizing beam splitter disposed between the optical module and the imaging unit.

FIG. 8 is a hybrid combination of FIGS. 5 and 7.

FIG. 9 is a schematic diagram showing a total internal reflecting prism for off axis orientation of components.

FIG. 10 is a hybrid combination of FIGS. 5 and 9.

FIG. 11 is a schematic diagram showing relative dimensions of the optical module and optical engine.

FIG. 12 are some representative rectilinear cross sections over which the present invention may uniformly illuminate.

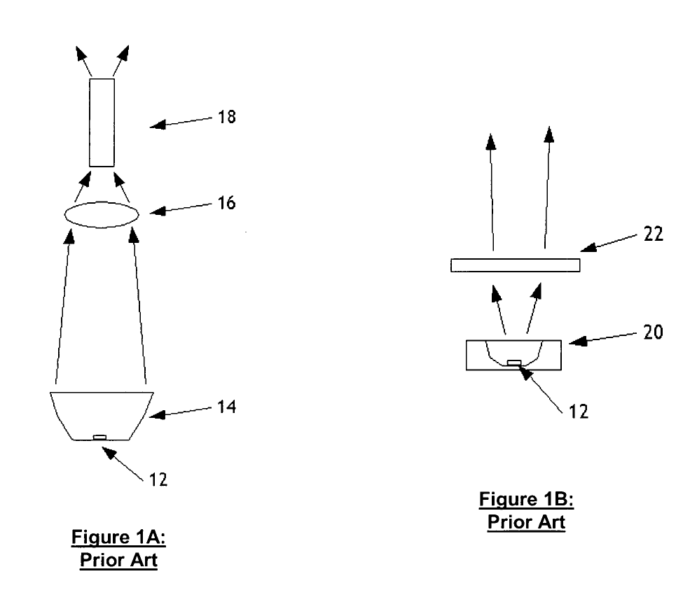

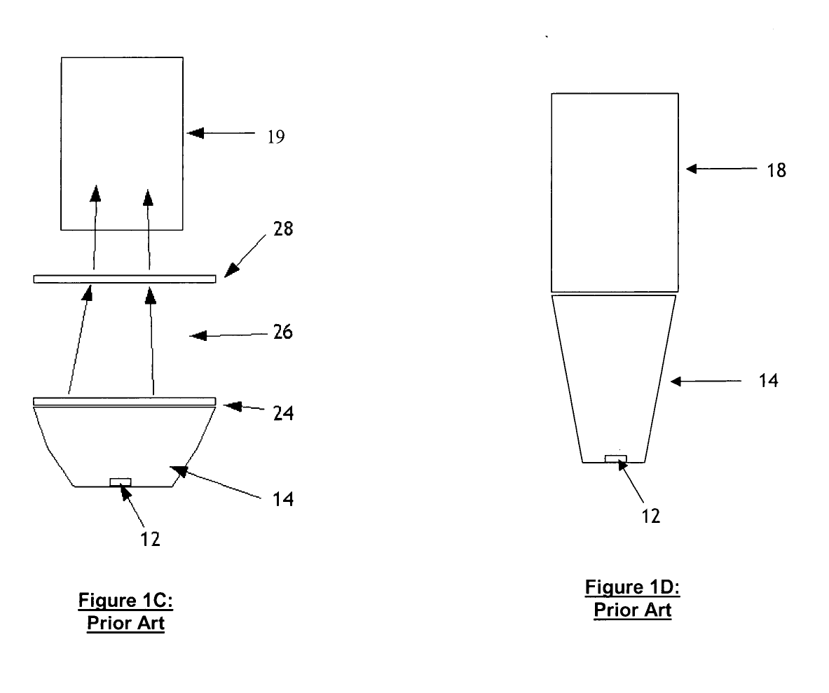

### DETAILED DESCRIPTION

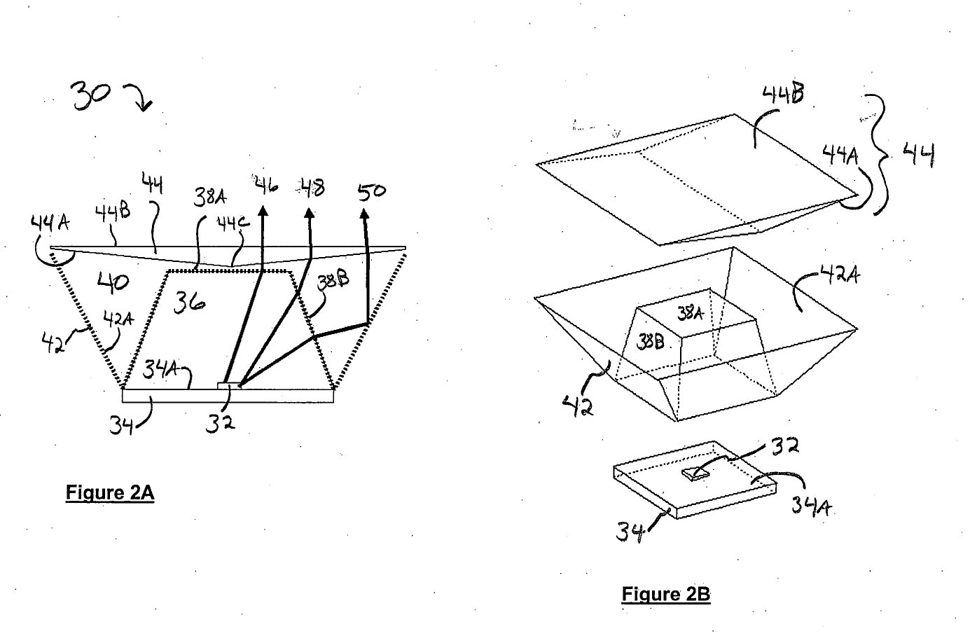

The inventors have reviewed the prior art approaches and found several inherent shortfalls that the present invention seeks to overcome. Specifically, the fact that prior art approaches use separate mechanisms for collection and distribution (beam forming) results in apparatus that do not lend themselves to easy miniaturization. The present invention performs both light collection from a source and distribution to the desired input field (i.e., for input to an optical engine) in a single unit which is inherently small and substantially smaller than prior art approaches. The present invention further considers the need to minimize losses within the collecting/distribution device and provides for heat sinking the light source. The preferred embodiment is detailed at FIGS. 2A-2B.

FIG. 2A is a cut-away plan view of an optical module 30 according to the preferred embodiment of the present invention. FIG. 2B is an exploded view of the same embodiment as shown in FIG. 2A. A multi-directional light source 32 such as an LED is disposed on a substrate 34. Light emanating from the source 32 passes through a first optical medium or material 36 having a first refractive index and is refracted at a boundary layer 38 into a second optical medium or material 40. The first and second optical mediums 36, 40 are optically transparent or substantially so at least to the intended wavelengths. The boundary layer 38 includes an upper surface 38A and side surfaces 38B, each of which are preferably planar. The boundary layer 38 consists of microstructure optics/features as described in the incorporated reference. The second optical medium 40 is bounded by the boundary layer surfaces 38A-B, by a series of reflective sidewall surfaces 42A of sidewalls 42, and by a lower refractive surface 44A of a lens 44. The reflective sidewall surfaces 42A preferably also include microstructure optics/features as described in the incorporated reference. Preferably, an opposed upper surface 44B of the lens 44 is planar and parallel to the upper surface 38A of the boundary layer. The lens 44 preferably defines a periphery that contacts the sidewalls 42 or at least very nearly so. An apex 44C of the lens defined by symmetrical lower lens surfaces 44A is preferably spaced from the upper surface 38A of the boundary layer, at least some minimal amount so that the apex 44C does not contact the boundary layer 38.

The substrate 34 may be heat sunk to draw heat from the source 32. Preferably, the substrate 34 has a high thermal conductivity, and is coupled to one or more cooling elements as known in the art. Importantly, a surface 32A of the substrate facing the source 32 is highly reflective to minimize losses through absorption and scattering of the multi-directional light emanating from the source 32 toward the surface 32A.

The first optical medium has a refractive index greater than one, preferably between 1.3 and 1.7. When LED's are used as a light source, this refractive index raises the external efficiency of LED. The second optical medium may be air with a refractive index essentially one, or may be some other material optically matched to the refractive index of the first optical medium to direct light as desired toward the lens 44, as particularly described below with respect to the preferred embodiment.

The optical pathways are now described. In the preferred embodiment of FIGS. 2A-2B, three distinct optical pathways are defined. Rays that pass through the upper surface 38A of the boundary 38 follow a first optical path and are represented in FIG. 2A by a first exemplary ray 46, rays that pass though a side surface 38B of the boundary 38 and reflect from the sidewall surface 42A follow a third optical path and are represented in FIG. 2A by a third exemplary ray 50, and all other rays follow a second optical path and are represented in FIG. 2A by a second exemplary ray 48.

Rays along the first optical path 46 pass from the source through the first optical medium 36 and are refracted at the upper surface 38A of the boundary 38, pass through the second optical medium 40, and are refracted at the lower surface 44A of the lens. Rays along the second optical path 48 propagate similarly to those of the first path 46, except they pass through a side surface 38B of the boundary 38 rather than the upper surface 38A. Rays along the third optical path 50 pass from the source through the first optical medium 36 and are refracted at a side surface 38B of the boundary 38 and pass through the second optical medium 40. There, they are reflected from the sidewall surface 42A, pass again through the second optical medium 40, and are finally refracted at the lower surface 44A of the lens just as the other two rays 46, 48. The upper 38A and side 38B surfaces of the boundary 38 determine the first optical surface, which forms the desired spatial intensity distribution of light onto the second optical surface. The sidewall surfaces 42A determine the second optical surface for the rays along the third optical path and the lower lens surfaces 44A determine the second optical surface for the rays along the first and the second optical path, which surface forms the angular distribution of light to the desired input field to an optical engine (discussed below).

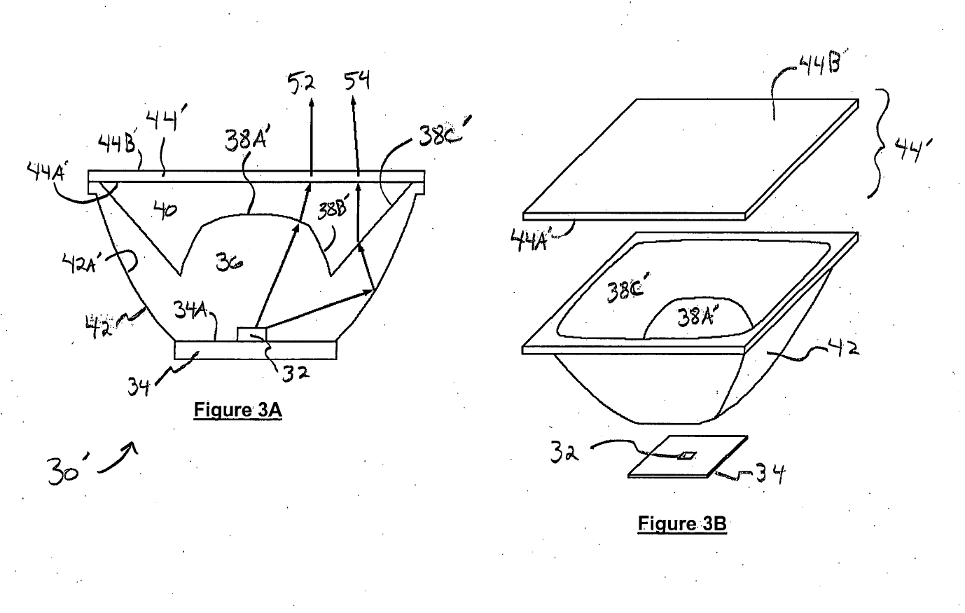

FIG. 3A is a cut-away plan view of an optical module 30′ according to an alternative embodiment of the present invention. FIG. 3B is an exploded view of the same embodiment as shown in FIG. 3A. Like components and surfaces are represented by like reference numbers and not further detailed except to explain differences in operation. An important distinction in this embodiment as compared to the preferred embodiment is that in FIGS. 3A-3B, the sidewall surfaces 42A′ are contacted by the first optical medium 36 rather than the second, and because of that the boundary is extended by surfaces 38C′ to meet the sidewall surfaces 42A′ (or the lens 44′) near the lens lower surface 44A′. In this alternative embodiment 30′ the boundary also defines an upper surface 38A′ and side surfaces 38B′. The extension surface 38C′ extends approximately parallel to a ray traced from the source 32 (though not necessarily co-linear with that parallel ray). The other distinction in this alternative embodiment 30′ as compared to the preferred embodiment 30 is that the upper surface 38A′ of the boundary and the sidewall surfaces 42A′ are circumferentially arcuate rather than a series of planar surfaces. This is shown generally in FIG. 3B. While either embodiment 30, 30′ may be made either planar or with varying degrees of curvature in the described and distinguished surfaces, the illustrated embodiments are deemed the best mode for the different embodiments given practical manufacturing considerations. In this alternative embodiment 30′, the boundary does not consist of microstructured optics/features, but in order to facilitate similar operation, the lens 44′ includes microstructured optics/features in either it's lower 44A or upper 44B surfaces and is because of that termed a micro-optical lens 44′.

In this alternative embodiment 30′, there are two distinct optical paths, termed herein a direct path represented by the ray 52 of FIG. 3A and an indirect path represented by the ray 54 of FIG. 3A. These terms are used only to avoid confusion with previously described first/second/third optical paths detailed with respect to the preferred embodiment. The direct optical path 52 is similar in principle to the first optical path 46 previously discussed: a light ray emanating from the source 32 passes through the first optical medium 36 and is refracted at the upper surface 38A′ or at the side surface 38B′ of the boundary, passes through the second optical medium 40 and is again refracted at the lower surface 44A of the micro-optical lens 44′. Rays following the indirect optical path 54 differ from any previously discussed, in that they pass through the first optical medium 36 and are reflected from the mirrored sidewall surface 42A′ back into the first optical medium 36. They are then refracted at the extended surface 38C′ of the boundary 38, pass through the second optical medium 40, and are again refracted at the lower surface 44A of the micro-optical lens 44. In this alternative embodiment, the boundary surfaces 38A′ and 38B′ and the sidewall reflective surfaces 42A′ determine the spatial intensity distribution of light to the micro-optical lens 44′, and the micro-optical lens 44′ modifies the angular distribution of the light to match any related optical engine. The microstructured optics/features previously noted as being along the lower surface 44A of the micro-optical lens 44′ may instead be on the upper surface 44B or both surfaces 44A-B.

The present invention collects multi-directional light from a small source, preferably a point source such as an LED or even an incandescent filament or arc lamp, and shapes the light (e.g., directs the rays) into a certain angular and spatial distribution. Uniform rectangular illumination is needed in many different applications, for example in micro-projectors. The present invention may achieve uniform rectangular illumination at aspect ratios of 3:4, 16:9, 16:10, and 1:2. Further, the present invention is not constrained to uniform illumination over a shape defined by right angles but may yield uniform illumination over a trapezoid or parallelogram as shown in FIG. 12, as well as the illustrated square and rectangle.

One important aspect of the present invention is the management of lighting efficiency in the design of the optical module 30, 30′. Heat sinking the source 32 to the substrate 34 as noted above is an important feature in order to keep the junction temperature of the LED within the efficient working region. A more fundamental tool is to use of microstructured optics/features in order to precisely manage etendue of the system. Etendue is a figure of merit for optical efficiency, and conservation of etendue provides that in any optical system, etendue cannot decrease but can at best remain unchanged in a lossless system. The present invention is designed to actively manage etendue throughout the optical pathways.

Etendue is a term that has been conceptualized as optical throughput. There are many etendue critical applications, where, to achieve a desired result, it is important that the etendue of the source is near to the etendue of the illumination field to be formed. In etendue critical applications, conservation of etendue requires that increases in etendue during the collection (over etendue of the light source) results in etendue losses later in the optical system. Because the surface emitting LED of the second conventional approach shown in FIG. 2B has larger etendue in comparison to the etendue of the LED chip inside it, losses are inherently high in the optical engine, when that system is used in etendue critical applications (detailed below). Further, the single beam shaper offers but one surface to shape the beam, and the spatial light distribution at the beam shaper is defined by the LED component, generally circular.

For a surface of arbitrary shape and light coming from a material with a refractive index nₗ, the etendue in its general form is defined as

$$E = \frac{{n}_{1}^{2}}{{n}_{2}^{2}} \int \int ⅆ A {\hat{e}}_{A} \cdot ⅆ Ω {\hat{e}}_{Ω} , \qquad ( 1 )$$

where n₁ and n₂ are the refractive indices of the optical mediums or materials; dA is the differential area element on the surface; ê_{A} is the surface normal vector corresponding to dA; dΩ is the differential solid angle element, and ê_{Ω} is the centroid direction vector corresponding to dΩ. Because etendue cannot be decreased through optical means, any losses in any component of an optical system carry through the entire system. That is, the etendue of a system is driven by the smallest of the etendues of its components.

Define an etendue critical system as one wherein the etendue of the system E_{system} and the etendue of the source E_{source} have the following relation:

$$\frac{{E}_{source}}{2} < {E}_{system} < 2 * {E}_{source} , \qquad ( 2 )$$

A micro-projector using a small microdisplay (approximately 0.55″ diagonal) and a LED source (approximately 1 mm×1 mm×0.1 mm in its size) is a good example of an etendue critical system.

In micro-projection systems, for example, the micro-display has a certain spatial extent and acceptance angle. The projection lens has similar limitations. Together, these limitations, along with other etendue limiting factors from other system components such as cross-dichroic prisms (X-cubes), cause the etendue of the system to be limited. To obtain high efficiency, the inventors have chosen the course of preserving etendue of the light beam in its original value of source etendue through the optical system until the etendue limiting factors are passed.

Etendue management may be practiced in simpler cases such as fiber to lens coupling, light collection from a fiber to a detector, or object illumination in a microscope. These are relatively simple as the source is emitting only into a certain numerical aperture, or all of the light emitted need not be collected (which is management of etendue for only a portion of the emitted light). Etendue management becomes increasingly difficult for more complex tasks, such as low power micro-projectors, in which all light that is emitted by the source (over a hemisphere with a reflective substrate) must be collected and delivered to the optical engine with a certain spatial and angular distribution. [The term “all light” is understood not to exclude real-world devices where losses may arise from the practical limitations of manufacturing, but to exclude devices whose design purposefully fails to collect a non-negligible amount of emitted light.] This distribution is a complex function of space, especially where uniform illumination is not cylindrically symmetric. Contributing to complexity of etendue management is that when the source is emitting into a very wide angle (e.g., 180° LED with a reflective substrate, 360° incandescent filament or arc lamp), the source cannot be mathematically approximated by a point source, and that the illumination is not cylindrically symmetric but illumination needs to be rectilinearly uniform. Most pressing for broad applications of any solution, beam shaping must be done in a small space to facilitate miniaturization.

The present invention effectively manages etendue along the entire optical pathway(s) through the optical module 30, 30′. The reflective substrate surface 34A limits losses that occur from the light source 32 emanating over a wide cone, and the reflective sidewall surfaces 42A, 42A′ also similarly limit losses. The preservation of the etendue of the source through this component itself and the use of microstructured optics/features enable the matching of the beam precisely to the input field of the optical engine, which prevent losses happening later in the optical engine. These are areas where large losses traditionally occur in the prior art approaches described above. The present invention limits optical losses to a maximum of about 30%, generally to about 20%, and typically about 10%, whereas losses in the prior art are generally on the order of about 70% in the same size. This enables the present invention to use LEDs as the light source 32 in such applications where traditional solutions need to use brighter and more inefficient sources. The particular arrangement of reflective and refractive surfaces enables the present optical module 30, 30′ to be made on the miniature-scale.

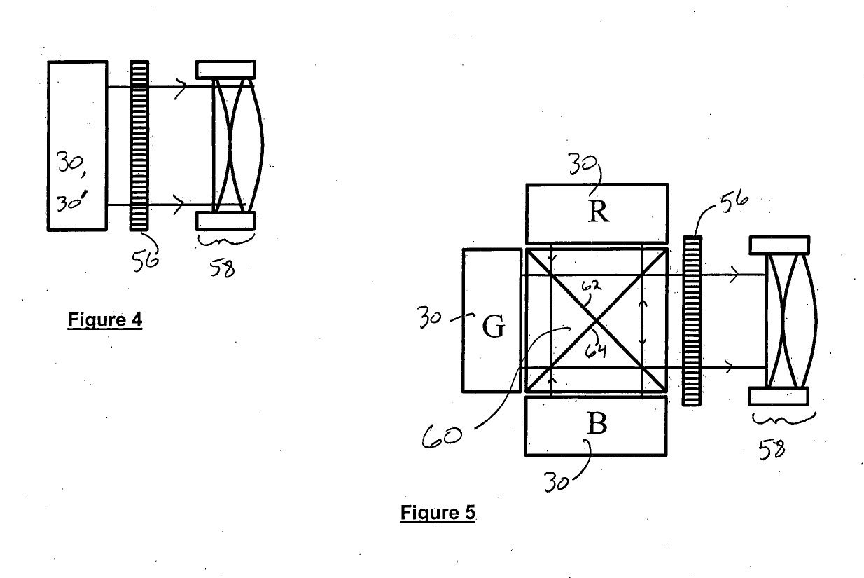

FIGS. 4-10 are schematic diagrams of one or more of the described optical modules may be disposed relative to an optical engine for completing an optical projector. In all instances, rays emanating from the optical module form the desired input field to the optical engine, which then forms a cross section that is preferably rectilinear rather than circular symmetric at the microdisplay, and further forms the desired uniform rectilinear image on the target. Examples of some but not all potential rectilinear cross sections of the beam at the microdisplay and at the screen are shown in FIG. 12.

In FIG. 4, the optical module 30, 30′ is positioned so that the rays emanate to a transmissive micro-display 56, which transmits the rays to an imaging unit 58 such as a series of focusing lenses as traditionally arranged in a projector having one optical axis. A transmissive micro-display 56 may be a LCD (liquid crystal display) or a MEMS (micro electro-mechanical system), to name but two. In a preferred embodiment, the light source 32 includes a white LED, and the micro-display 56 includes a color LCD panel, which together results in a color image at the screen/target (not shown). An alternative embodiment is to make a one-color image by using a monochromatic light source 32 (for example, a red LED) together with a non-color micro-display 56, such as monochromatic LCD. Of course embodiments between these two are also possible: a light source 32 exhibiting a spectrum anywhere between a full visible spectrum and a single color, and/or a micro-display 56 that may be any number of colors.

FIG. 5 depicts the same relative arrangement of transmissive micro-display 56 and imaging unit 58, but with three optical modules 30-R, 30-G, 30-B arranged about sides of an X-cube 60 and the transmissive micro-display 56 aligned with an optical axis at the output side of the X-cube 60. Preferably, the modules each include a source 32 emanating in a different portion of the visible light spectrum, or at least emanating over a spectrum range having different center wavelengths (where the sources are not mono-chromatic). Indicated are red, green, and blue LED sources. The optical module 30-G with the green LED source is oriented similar to that described in FIG. 4; the green emanating rays pass undeflected through two filters 62, 64 that each bisect the X-cube 60. Most preferably, the filters 62, 64 are dichroic mirrors that operate to reflect light of a desired wavelength (or range) and pass light of other wavelengths. The optical module 30-R with the red LED source is oriented perpendicular to the module 30-G with the green LED, and its red emanating rays are at least partially reflected by one of the dichroic mirrors 62 to align with the system optical axis defined by the transmissive micro-display 56 and imaging unit 58. Similarly, the optical module 30-B with the blue LED source is also oriented perpendicular to that with the green LED and facing the red module 30-R, and its blue emanating rays are at least partially reflected by the other of the dichroic mirrors 64 to align with the system optical axis. Either a monochromatic or a color micro-display 56 can be used. If a monochromatic micro-display 56 is used, light sources 32 with different colors may illuminate the micro-display 56 sequentially in time. The micro-display 56 then need to be sufficiently fast for a flicker-free screen image as viewed by the human eye. The X-Cube 60 is typically made of glass, by securing/adhering four glass prisms together with thin film dichroic coatings. Alternatively, the X-cube 60 can be made by arranging glass sheets with thin film coatings in an X-form.

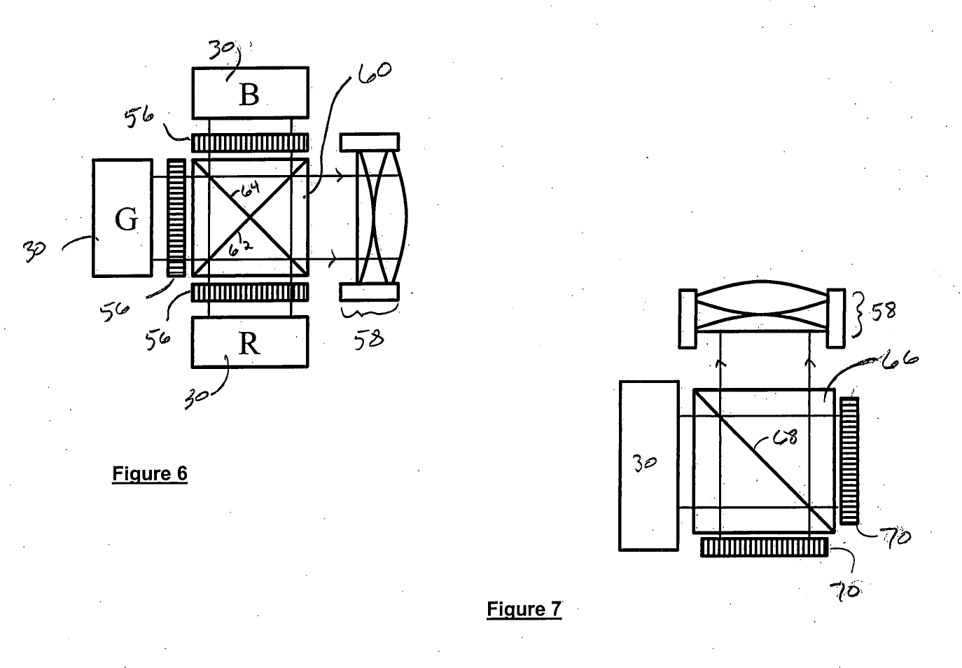

FIG. 6 is similar to the arrangement of FIG. 5, except a transmissive micro-display 56 is disposed between each optical module 30 and the X-cube 60 rather than between the X-cube 60 and the imaging unit 58. In this arrangement, the system optical axis is defined by the imaging unit 58, which is also the same as that defined by the optical module 30-G whose rays are not reflected by the X-cube 60.

The three abovementioned optical engine configurations of FIGS. 4-6. which use transmissive micro-displays 56, enable very small projector sizes, starting from below 1 cc up to 10 cc, including the lens.

FIG. 7 illustrates an embodiment where rays emanating from the optical module 30 enter into a polarizing beam splitter 66 where a splitter plate 68 divides the beam into different polarization components. One such component is reflected back from one reflective micro-display 70 and the other such component is reflected back from another reflective micro-display 70 oriented at an angle (preferably perpendicular) to the first. The separate polarized components are re-joined along the system optical axis and transmitted to the imaging unit 58. Examples of reflective micro-displays 70 include reflective LCDs, and LCoS (liquid crystal on silicon). It is possible to use a white light source 32 and a color micro-display 70 if a color image is desired. It is also possible to use only one micro-display 70, in which case the other polarization component is lost. If two micro-displays 70 are used, it is possible to present 3D-images by modulating different micro-displays 70 with different images (right eye and left eye images) and then using a polarization preserving screen (such as a metallized reflection screen or rear-projection screen) and polarizing glasses in viewing.

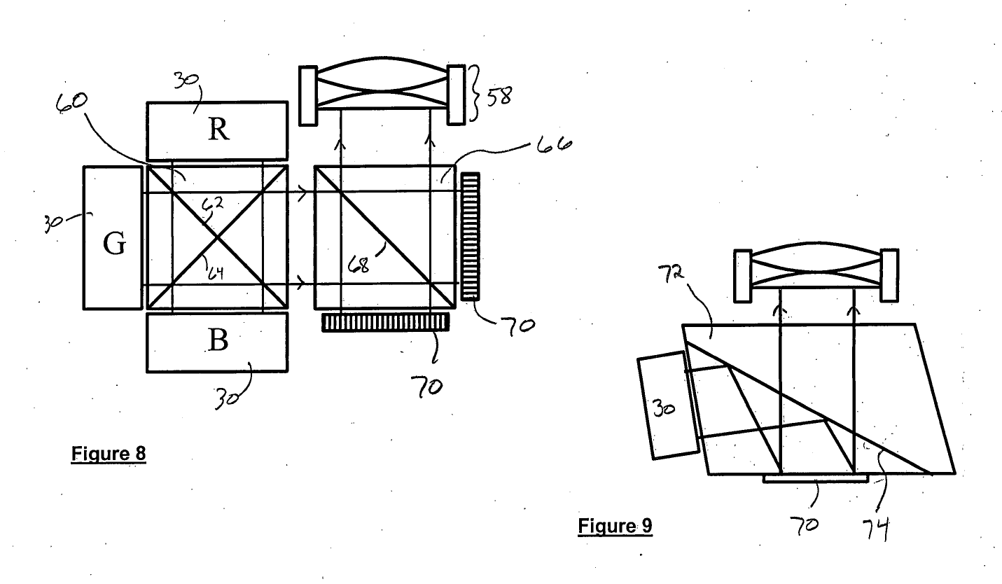

FIG. 8 is essentially a combination of FIGS. 5 and 7, but without the transmissive micro-display 56 of FIG. 5. The polarizing beam splitter (PBS) 66 and reflective micro-displays 70 are as described with reference to FIG. 7, but in the embodiment of FIG. 8, the input to the PBS 66 is from an X-cube 60 that aligns rays from three chromatic optical modules 30 as described with reference to FIG. 5. In FIG. 8, light from different sources are combined, then the combination is separated by polarization and recombined as it is re-directed toward the imaging unit 58.

FIG. 9 shows that the various optical pathways between the optical module 30 and the imaging unit 58 are not limited to normal angles to one another. Light from the optical module 30 enters into a total internal reflection (TIR) prism 72 and is reflected by total internal reflection at a surface 74 toward a reflective micro-display 70. From there, light is reflected back toward the surface 74, which it passes through, and to the imaging unit 58. This configuration is especially beneficial with DMD-microdisplay because the same microdisplay can be used for both polarization components.

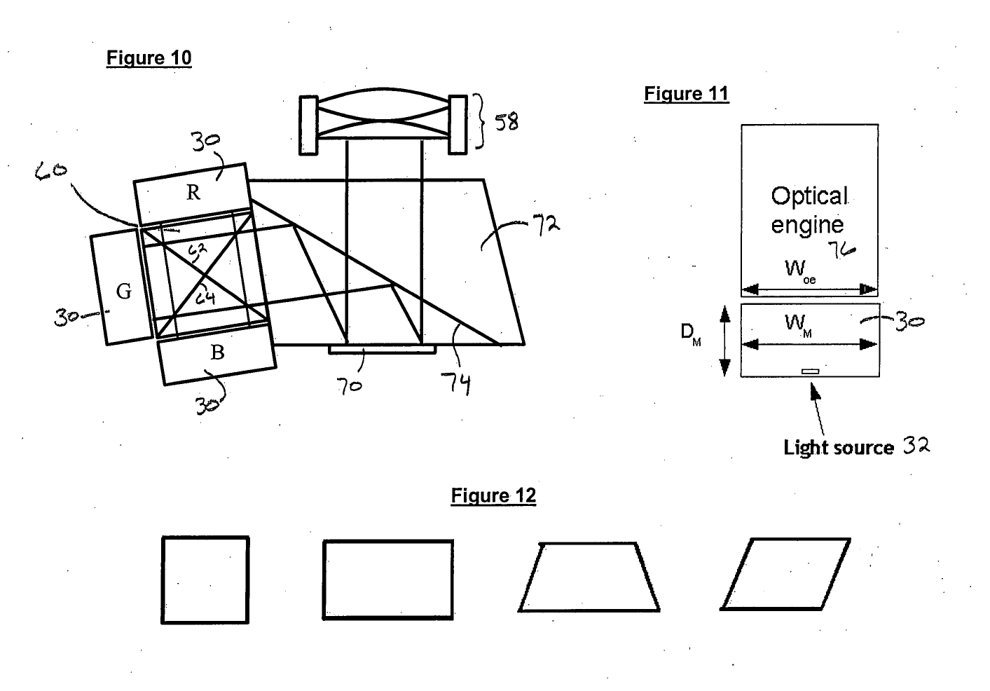

FIG. 10 is a schematic diagram of a combination of FIGS. 5 and 9, but without the transmissive micro-display 56 of FIG. 5. Light from the various optical modules 30-R, 30-G, 30-B are combined into a single path as described with reference to FIG. 5 and input into a TIR prism 72 as described with reference to FIG. 9. Within the TIR prism 72, light is reflected by total internal reflection as described above from the surface 74 and then reflected again from the reflecting micro-display 70, where it aligns with the optical axis defined by the imaging unit 58 and is directed toward it.

In the abovementioned optical engine configurations for micro-projection, other performance enhancing components can be used also, as known in the field of projector optics. For example, additional polarizers can be used to enhance image contrast and quarter wavelength plates can be used in enhancing uniformity, in LCD and LCoS engines. Thin film antireflection coatings can be used in optically transmissive surfaces to eliminate unwanted reflections. PBS and X-Cubes can be made of glass blocks glued together or they can be air-spaced consisting glass sheets with functional coatings. It is preferable for etendue management that the optical modules 30, 30′ are disposed immediately adjacent to the optical engine (X-cube 60, polarizing beam splitter PBS 66, or TIR prism 72) so that the lens 44, 44′ of the module 30, 30′ faces an input side of the optical engine. However, variations of the illustrated embodiments may impose a space or even additional components between the modules 30, 30′ and the optical engine so long as they remain optically coupled to one another, wherein the output of the optical modules 30, 30′ is directed to an input of the optical engine, regardless of whether the optical axis between them is a straight line or reflected/redirected by the other intervening components.

FIG. 111 is a schematic diagram showing dimensions of the optical module 30 relative to the optical engine 76. The optical engine may be any of the various arrangements of optical components described in FIGS. 4-10, excluding the optical module 30, 30′ and including the X-cube 60, the PBS 66, and the TIR prism 72. Where the width of the optical input field of the optical engine 76 is denoted as WOE, the width of the optical module 30, 30′ is denoted as WM, and the depth of the optical module is denoted as DM, the following relations preferably hold for any of the various embodiments of the present invention:
W_{M}<2*W_{OE} (2)
D_{M}<2*W_{OE} (3)

Preferably, D_{M}<W_{M} also. In the preferred embodiment, the width of the optical module W_{M} is less than about 1.1 times the width of the optical engine input field W_{OE}, and the depth of the optical module D_{M} is about one half the width of the optical engine input field W_{OE}. The present invention is deemed particularly adapted to the micro-optics regime, defined as having diffractive optical structures/feature sizes between about 0.01 μm and about 100 μm, and/or refractive micro-optical structures/feature sizes between about 0.5 μm and about 1000 μm, and/or micro-prism arrays and/or micro-lens arrays. Preferably, the optical module 30, 30′ is less than about 2.5 cm on each width and length side and has a depth of about less than 1.5 centimeters.

Whereas the above description has primarily assumed a LED as the light source 32, any multi-directional light source may be used, such as an incandescent bulb or filament, a gas discharge lamp, etc. The present invention has been designed assuming that the source emits into a wider angle than that defined and limited by the parallaxial region.

Although described in the context of particular embodiments, it will be apparent to those skilled in the art that a number of modifications and various changes to these teachings may occur. Thus, while the invention has been particularly shown and described with respect to one or more preferred embodiments thereof, it will be understood by those skilled in the art that certain modifications or changes may be made therein without departing from the scope and spirit of the invention as set forth above, or from the scope of the ensuing claims.

What is claimed is:

1. A method for manipulating light comprising:
emitting light from a multi-directional source;
collecting and spatially distributing the light using at least one patterned optical surface while substantially preserving etendue of the emitted light; and
distributing the collected light angularly using at least one second optical surface while substantially preserving the etendue of the collected light.

2. The method of claim 1 wherein distributing the collected light comprises distributing the collected light across a rectilinear imaging surface with substantially uniform illumination.

3. The method of claim 1 wherein the collecting and distributing is within a volume of about less than about 10 cubic centimeters.

4. The method of claim 1 as applied to at least two distinct light sources, the method further comprising:
collecting light from the at least two distinct light sources to one optical path using a color filter matched to each distinct light source; and
spatially modulating the light to project a color image.

5. The method of claim 1 further comprising:
separating the collected and distributed light into at least two wavelength-defined bands.

6. An optical module comprising:
a multi-directional light source;
a substrate having a reflective surface facing the light source;
a first optical medium defining a refractive index greater than unity, and disposed such that the first optical medium and the reflective substrate substantially envelop the light source;
a second optical medium in contact with the first optical medium and defining a boundary therebetween;
reflective sidewalls bounding a lateral portion of the second optical medium; and
a lens defining a lower surface in contact with the second optical medium and spaced from the first optical medium;
arranged such that light from the source passing through the lens follows a first and a second optical path, the first optical path comprising refraction at the boundary followed by refraction at the lens, and the second optical path comprising refraction at the boundary followed by reflection from a sidewall followed by refraction at the lens.

7. The optical module of claim 6 wherein said light following the first and second optical paths forms a rectilinear cross section at the lens.

8. The optical module of claim 7 in combination with an illumination target disposed such that said light forming the rectilinear cross section exhibits a substantially uniform illumination intensity at the illumination target.

9. The optical module of claim 8 wherein the target comprises a micro-display.

10. The optical module of claim 6 wherein the reflective sidewalls define a depth less than about 1.5 cm, and a width and length less than about 2.5 cm each.

11. The optical module of claim 6, further comprising micro-optical diffractive structures defined along the boundary.

12. The optical module of claim 6 optically coupled to an optical engine that defines an optical input field width WOE, wherein a longest width between opposed reflective sidewalls of the optical module is less than about 1.1*W_{OE}.

13. The optical module of claim 6, wherein the first optical medium is in contact with the light source.

14. The optical module of claim 6 wherein the lower surface of the lens defines an apex.

15. The optical module of claim 6 having a first-color light source, in combination with a second optical module of claim 6 having a second color light source, in combination with a third optical module of claim 6 having a third color light source, said three optical modules arranged about three sides of an X-cube optical engine such that each is optically coupled to the optical engine.

16. The optical modules of claim 15 further comprising a transmissive micro-display disposed along an optical axis of the optical engine.

17. The optical engine of claim 15, further comprising for each optical module, a transmissive micro-display disposed between the optical module and the optical engine.

18. The optical module of claim 6 in combination with a polarizing beam splitter and a first and second reflective micro-optical display, said optical module and first and second reflective micro-displays disposed about three sides of the polarizing beam splitter.

19. The optical module of claim 6, in combination with a total internal reflection TIR prism and a reflective micro-display, said optical module optically coupled to one side of the TIR prism and the reflective micro-optical display is optically coupled to an adjacent side of the TIR prism.

20. The optical module of claim 6 in combination with an optical engine to define an etendue critical optical system, wherein micro-optical features are disposed along the first and second optical paths so as to preserve etendue in the system such that optical losses do not exceed 30% between the light source and an output of the optical engine.

21. The optical module of claim 20, wherein the optical losses do not exceed about 10%.

22. An optical module comprising:
a multi-directional light source;
a substrate having a reflective surface facing the light source;
a first optical medium defining a refractive index greater than unity, and disposed such that the first optical medium and the reflective substrate substantially envelop the light source;
a second optical medium in contact with the first optical medium and defining a boundary therebetween;
reflective sidewalls bounding a lateral portion of the first optical medium; and
a lens defining a lower surface in contact with the second optical medium and spaced from the first optical medium;
arranged such that light from the source passing through the lens follows a first and a second optical path, the first optical path comprising refraction at the boundary followed by refraction at the lens, and the second optical path comprises reflection from a sidewall followed by refraction at the boundary followed by refraction at the lens.

23. The optical module of claim 22 in combination with an illumination target disposed such that said light following the first and second optical paths forms a rectilinear cross section at the illumination target.

24. The optical module of claim 23 wherein said light forming the rectilinear cross section exhibits a substantially uniform illumination intensity at the illumination target.

25. The optical module of claim 24 wherein the target comprises a micro-display.

26. The optical module of claim 22 wherein the reflective sidewalls define a depth less than about 1.5 cm, and a width and length less than about 2.5 cm each.

27. The optical module of claim 22, wherein at least a portion of the boundary through which the second optical path passes defines a line substantially parallel to a light ray emanating directly from the light source.

28. The optical module of claim 22, further comprising micro-optical diffractive structures defined along a surface of the lens.

29. The optical module of claim 22 optically coupled to an optical engine that defines an optical input field width WOE, wherein a longest width between opposed reflective sidewalls of the optical module is less than about 1.1*W_{OE}.

30. The optical module of claim 22, wherein the first optical medium is in contact with the light source.

31. The optical module of claim 22 having a first-color light source, in combination with a second optical module of claim 6 having a second color light source, in combination with a third optical module of claim 6 having a third color light source, said three optical modules arranged about three sides of an X-cube optical engine such that each is optically coupled to the optical engine.

32. The optical modules of claim 31 further comprising a transmissive micro-display disposed along an optical axis of the optical engine.

33. The optical engine of claim 31, further comprising for each optical module, a transmissive micro-display disposed between the optical module and the optical engine.

34. The optical module of claim 22 in combination with a polarizing beam splitter and a first and second reflective micro-optical display, said optical module and first and second reflective micro-displays disposed about three sides of the polarizing beam splitter.

35. The optical module of claim 22, in combination with a total internal reflection TIR prism and a reflective micro-display, said optical module optically coupled to one side of the TIR prism and the reflective micro-optical display is optically coupled to an adjacent side of the TIR prism.

36. The optical module of claim 22 in combination with an optical engine to define an etendue critical optical system, wherein micro-optical features are disposed along the first and second optical paths so as to preserve etendue in the system such that optical losses do not exceed 30% between the light source and an output of the optical engine.

37. The optical module of claim 36, wherein the optical losses do not exceed about 10%.
